(19) United States
(12) Patent Application Publication
(10) Pub. No.: US 2002/0069481 A1
(43) Pub. Date: Jun. 13, 2002

(54) Door hinge check for a vehicle door

(76) Inventors: Trevor P. Ashline, Rock Hill, SC (US); Marion Jack Ince, Mount Holly, NC (US); William Wesley Sitton, Charlotte, NC (US); Edward Joseph Wey, Waxhaw, NC (US); Ross Alan Gresley, Tega Cay, SC (US); Thomas C. Catrett II, Waxhaw, NC (US); Manu Ben Gidwani, Charlotte, NC (US); Mark Edwin Yost, Matthews, NC (US); Hans Werner Koch, Charlotte, NC (US); Joseph Richard Walto, Tega Cay, SC (US); Bernd Rainer Abel, Cheraw, SC (US)

Correspondence Address: Henry M. Feiereisen, 350 Fifth Avenue, Suite 3220, New York, NY, 10118, US

(21) Appl. No.: 09/960,844

(22) Filed: Sep. 21, 2001

Related U.S. Application Data
(60) Provisional application No. 60/234,120, filed on Sep. 21, 2000.

(51) Int. Cl. E05F 3/00

(52) U.S. Cl. 16/49

(57) ABSTRACT

A compact door check of modular design for a vehicle door is described that can be integrated in the door hinge and mated with many types of hinges and door assemblies. The door check according to the invention is includes a housing affixed to a first half of the door hinge, a shaft extending through the housing and connecting the other half of the door hinge to the first half to allow the first half to rotate about the shaft, and a detent mechanisms defining a plurality of detent positions of the door hinge. The detent mechanism is enclosed in the housing so as to be sealed against the environment to prevent contaminants and debris from affecting the operation of the door check.

### CROSS-REFERENCES TO RELATED APPLICATIONS

This application claims the benefit of prior filed provisional application, Appl. No. 60/234,120, filed Sep. 21, 2000, pursuant to 35 U.S.C. 119(e), the subject matter of which is incorporated herein by reference.

### BACKGROUND OF THE INVENTION

The invention is directed to a door hinge check for a vehicle door, and more particularly to a door hinge check forming a sealed assembly to keep out debris and contaminants.

Door hinge checks for a vehicle door can control pivotal movement of a vehicle door between a closed position and one or more open positions through a defined number of detent positions. The door check can be incorporated into the door hinge mechanism.

Commonly employed door checks tend to have a limited number of detent positions defined by coil springs and rollers. The door checks are usually quite large, are not paintable and hence are added to the car body after the paint operation in the automotive assembly plant. This adds operational steps to the automobile assembly process and makes assembly of the car more expensive. Moreover, the door checks are typically not sealed against the environment, allowing moisture and dirt to degrade their operation over time.

Several conventional door check mechanisms are presently employed in the automotive industry. The most commonly used are: (1) leaf spring and roller type (Ford); (2) torsion bar type (Audi); (3) slide bayonet type (VW, Ford, GM); and (4) coil spring, cam and roller type (GM). Other known door check mechanisms use a plastic detent bar, which requires additional space within the door panel.

Most present door checks require openings/holes be provided in either the door and/or the vehicle's “A” pillar, thus requiring additional costly local reinforcement measures. An example is the slide bayonet type mentioned above. Other door checks, such as the frequently employed cam and roller configuration, are also not sealed from contaminants, have a limited number of detent positions, and cannot be painted at same time the vehicle is painted. The limited number of detent positions limits the incremental opening/rest positions of the door. Conventional door checks tend to be bulky and take up an undesirable amount of package space between the vehicle door and body structure. In addition, most door checks require a strut or hold open fixture at time of assembly, adding cost and time on the assembly line.

It is therefore desirable to provide a compact door check which is of a modular design that can be integrated in the door hinge and mated with many types of hinges and door assemblies. The door check should be paintable and capable of being assembled in the vehicle prior to the paint application. This would allow the automobile manufacturer the opportunity to reduce steps in the assembly line. The door check should hold the door open under specified conditions and should also be capable of having multiple door stop (or detent) positions at different intervals with different load ratings, approaching the feel of an infinite unit. The check should also be in form of a sealed unit to keep out foreign objects and debris.

Furthermore, the door check should be quiet in operation and be capable of a maximum locking torque to 60 Nm in full open position.

### SUMMARY OF THE INVENTION

The invention is directed to a door check for a vehicle door that is sealed against the environment and easy to assemble. According to one aspect of the invention, a door catch for a door hinge includes a housing affixed to a first half of the door hinge, a shaft extending through the housing and connecting the other half of the door hinge to the first half to allow the first half to rotate about the shaft, and a detent mechanisms defining a plurality of detent positions of the door hinge. The detent mechanism is enclosed in the housing so as to be sealed against the environment to prevent contaminants and debris from affecting the operation of the door check.

Advantageous embodiments may include one or several of the following features. The detent mechanism may include a detent plate with detents, wherein the detent plate is secured to the housing. The detent mechanism can also have an arm keyed to the shaft and supporting a roller. The detent plate is biased against the roller and the shaft is non-rotatably secured to the other half of the door hinge. The detent plate can be supported in the housing by a pivot pin and biased against the roller by a spring. The spring can be an elastomer spring; alternatively, in this or other embodiments, coil springs and/or belleville springs can be employed.

In another advantageous embodiment, the detent plate can be affixed to the housing, and a support can be keyed to the shaft which is non-rotatably secured to the other half of the door hinge, supporting at least one ball or needle roller. The ball(s) or needle roller(s) is/are biased against the detent plate either in a direction perpendicular or parallel to the longitudinal direction of the shaft.

In yet another advantageous embodiment, one or two circular detent plates can be arranged at respective end sections of the shaft which penetrates the center of the detent plate(s). In this embodiment, the support associated with each detent plate is in the form of a cage and thrust plate, wherein the respective thrust plate is biased against the detent plate in a direction parallel to the longitudinal direction of the shaft.

In still another advantageous embodiment, the detent mechanism can include a detent sleeve operatively connected to the shaft which is non-rotatably secured to the other half of the door hinge. A cage is secured to the housing and supports at least one roller. In this case, the roller is biased against the shaft with the detent sleeve. The detent sleeve can be either a separate element or formed integrally with the shaft. The shaft does not need to be made of a solid material, for example in form of a hinge pin, but can also be formed as a hollow tube.

In another advantageous embodiment, the detent mechanism includes a plurality of detents being formed integrally with the housing, and a cage secured to the shaft and supporting at least one roller. The shaft is non-rotatably secured to the other half of the door hinge. The roller(s) is/are biased against the housing in a direction perpendicular to the longitudinal direction of the shaft for engagement with the detents.

### BRIEF DESCRIPTION OF THE DRAWING

Other features and advantages of the present invention will be more readily apparent upon reading the following description of preferred exemplified embodiments of the invention with reference to the accompanying drawing, in which:

FIG. 1A is a top view of a first embodiment of a sealed door check mechanism according to the invention in an open door position;

FIG. 1B is a top view of the sealed door check mechanism of FIG. 1A in a detent door position;

FIG. 1C is a top view of the sealed door check mechanism of FIG. 1A in a closed door position;

FIG. 1D is a cross-sectional view of the sealed door check mechanism of FIG. 1C taken along the line A-A;

FIG. 1E is a cross-sectional view of the sealed door check mechanism of FIG. 1C taken along the line B-B;

FIG. 2A is a cross-sectional view of a second embodiment of a sealed door check mechanism according to the invention;

FIG. 2B is a cross-sectional view of a modification of the sealed door check mechanism of FIG. 2A;

FIG. 2C is a cross-sectional view of a another modification of the sealed door check mechanism of FIG. 2A;

FIG. 3A is a cross-sectional view of a third embodiment of a sealed door check mechanism according to the invention;

FIG. 3B is a cross-sectional view of a modification of the sealed door check mechanism of FIG. 3A;

FIG. 3C is a cross-sectional view of another modification of the sealed door check mechanism of FIG. 3A;

FIG. 3D is a cross-sectional view of yet another modification of the sealed door check mechanism of FIG. 3A;

FIG. 4A is a top view of a fourth embodiment of a sealed door check mechanism according to the invention;

FIG. 4B is a top view of a modification of the sealed door check mechanism of FIG. 4A;

FIG. 5A is a top view of a fifth embodiment of a sealed door check mechanism according to the invention in an open door position;

FIG. 5B is a top view of the sealed door check mechanism of FIG. 5A in a detent door position;

FIG. 5C is a top view of the sealed door check mechanism of FIG. 5A in a closed door position;

FIG. 5D is a cross-sectional view of the sealed door check mechanism of FIG. 5B taken along the line B-B;

FIG. 5E is a cross-sectional view of the sealed door check mechanism of FIG. 5C taken along the line A-A;

FIG. 6A is a top view of a sixth embodiment of a sealed door check mechanism according to the invention in an open door position;

FIG. 6B is a top view of the sealed door check mechanism of FIG. 6A in a detent door position;

FIG. 6C is a top view of the sealed door check mechanism of FIG. 6A in a closed door position; and

FIG. 6D is a cross-sectional view of the sealed door check mechanism of FIG. 6C taken along the line A-A.

### DETAILED DESCRIPTION OF PREFERRED EMBODIMENTS

The invention is directed to a door check mechanism for a vehicle. In particular, the door check mechanism described herein can be integrated in the door hinge of the vehicle door and sealed from the environment so as to keep out contaminants and debris. It will be understood that the housing seal may not provide a hermetic seal against vapors and gases, which could be achieved by providing additional sealing members.

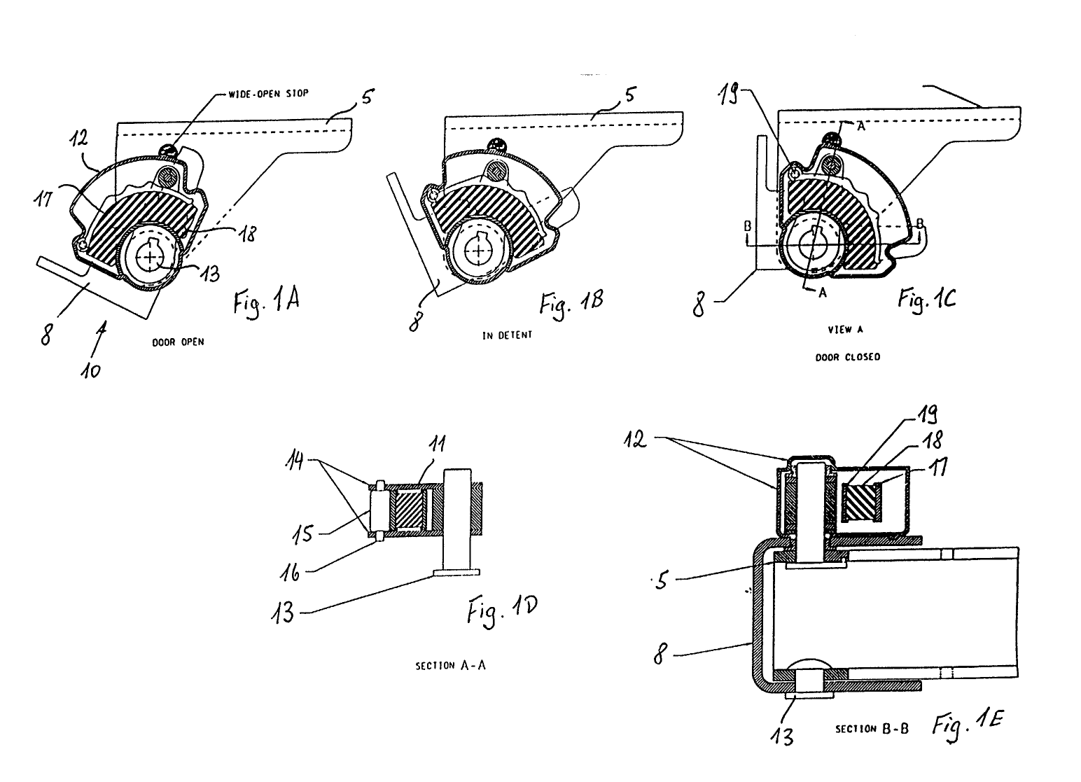

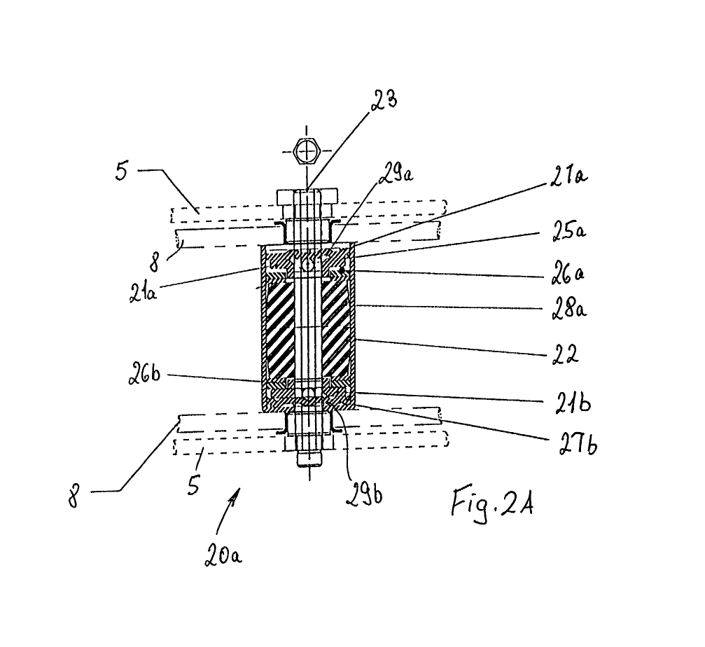

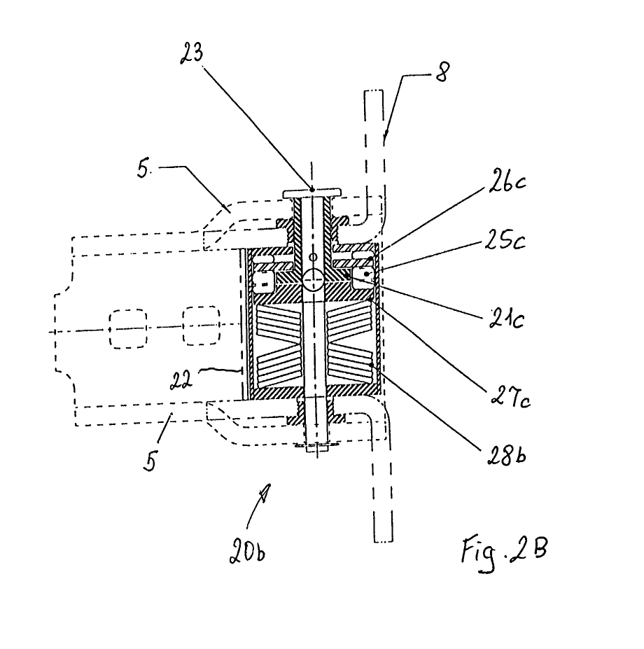

A first embodiment of the door check mechanism according to the invention is shown in FIGS. 1A-1E. The door check mechanism 10 has a fixed member 5 attached to the vehicle frame (not shown) and a closure member 8 (door hinge) pivotally moveable in relation to the vehicle frame about a pivot pin 13. A housing 12 is fixedly attached to one half of the door hinge, with the pivot pin 13 affixed to the other half of the door hinge to support the arm assembly 11. The arm assembly has two arms 14 which are locked to the pin 13 at one end, and to a roller 15 and axle 16 at the other end. The roller 15 is forced to roll along the detent plate 17 that is pinned at one end by pivot axle 19. A spring member 18 is supported on an inside spring support 19 that can be integrally formed with the housing 12, and biases the detent plate 17 outwardly against the detent plate 17.

The door positions are defined by engagement of the geometrically shaped elements of the detent plate 17 with the roller 15 in the various exemplary detent positions shown in FIGS. 1A-C. FIG. 1A shows the vehicle door in the open position, FIG. 1B in a detent position, and FIG. 1C in the closed position.

The arresting force and angular position of the door check integrated into the door hinge can be adjusted by changing the profile of the detent plate 17 and/or the pressure of the spring 18. The mechanism is modular in design and can be used for either a right or left hand door and can be integrated into different hinge mounting styles.

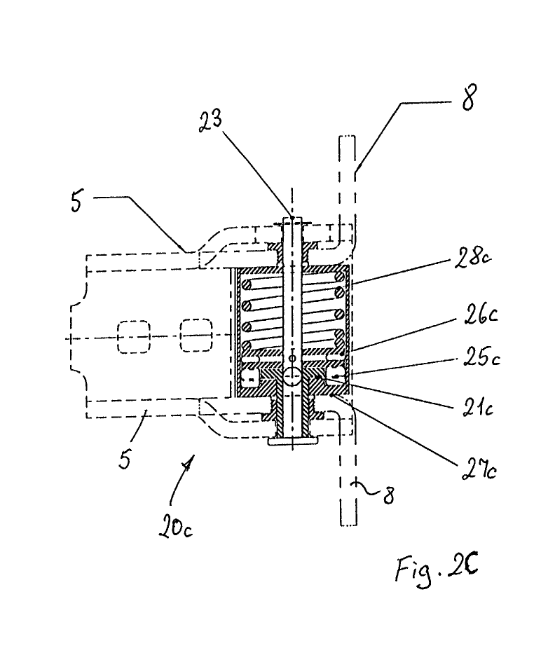

A second embodiment of the door check mechanism according to the invention is shown in FIGS. 2A-2C. Like the first embodiment, the door check mechanism includes a fixed member 5 which is attached to the vehicle frame (not shown) and a closure member 8 (door hinge) which is pivotally moveable in relation to the vehicle frame about a pivot pin or hinge pin 23. The door check device represented herein is axial in operation and shown in three modifications which differ primary in the spring type and the arrangement of the rollers. The first design (FIG. 2A) has an elastomer spring and dual roller plates, wherein the other two designs have belleville type springs (FIG. 2B) and compression type springs (FIG. 2C).

Referring first to FIG. 2A, two sets of rollers 25a, 25b which engage with recesses or detents 29a, 29b formed in detent plates 27a, 27b are indexed in different phases so as to provide a larger number of detent positions. A spring 28a biases respective thrust plates 26a, 26b against the rollers 25a, 25b. The outer half 5 of the door hinge is fixed to the vehicle body (not shown) and keyed to the hinge pin 23. The hinge pin 23 is keyed to both upper and lower cages 21a, 21b.

The inner half 8 of the hinge (the part of the hinge affixed to door) is keyed to the outer housing 22. The outer housing 22 is keyed to the detent plates 27a, 27b.

When the door is opened or closed, the outer housing 22 and the detent plates 27a, 27b rotate relative to the hinge pin 23 and cages 21a, 21b, which push the rollers 25a, 25b in and out of the detents 29a, 29b.

As the rollers 25a, 25b move from the detents to the peaks of the detent plates 27a, 27b, vertical motion of the rollers 25a, 25b results. This vertical motion compresses the spring 28a, creating the desired resistance to door motion at designated positions of the door. The magnitude of the resistance to door motion may be changed by altering the force produced by the spring 28a. The number and location of door positions may be changed by altering the geometry of the detent plates 27a, 27b.

Referring now to the modifications of the second embodiment depicted in FIGS. 2B and 2C, unlike the embodiment of FIG. 2A, the door check mechanisms 20b and 20, respectively, have only one sets of rollers 25c which engage with recesses or detents 29c formed in detent plates 27c is employed. As described before with reference to FIG. 1A, a spring 28c which can be a belleville type spring 28b (FIG. 2B) or a compression type springs 28c (FIG. 2C) biases a thrust plates 26c against the rollers 25c. The outer half 5 of the door hinge is fixed to the vehicle body (not shown) and keyed to the hinge pin 23. The hinge pin 23 is keyed to the cage 21c. The inner half 8 of the hinge (the part of the hinge affixed to door) is keyed to the outer housing 22. The outer housing 22 is keyed to the detent plate 27c. In all other aspects, the operation of the door checks depicted in FIGS. 2B and 2C is identical to that of the door check depicted in FIG. 2A.

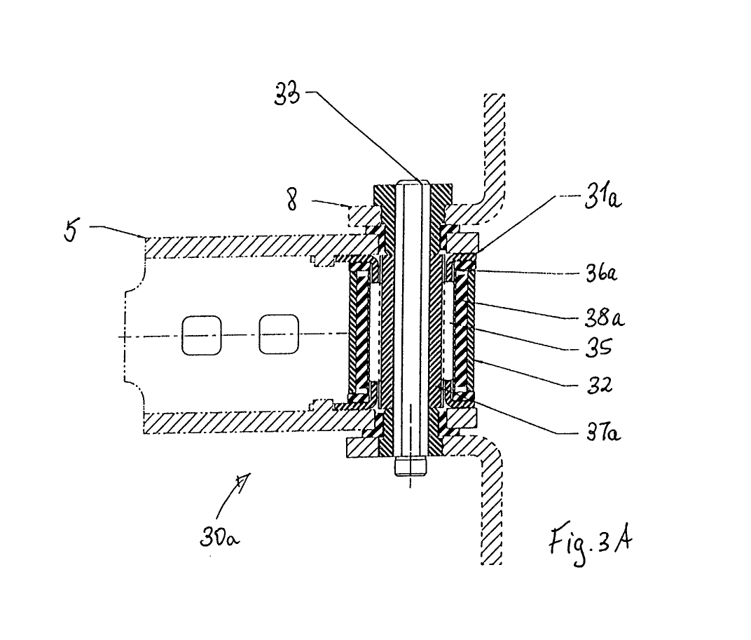

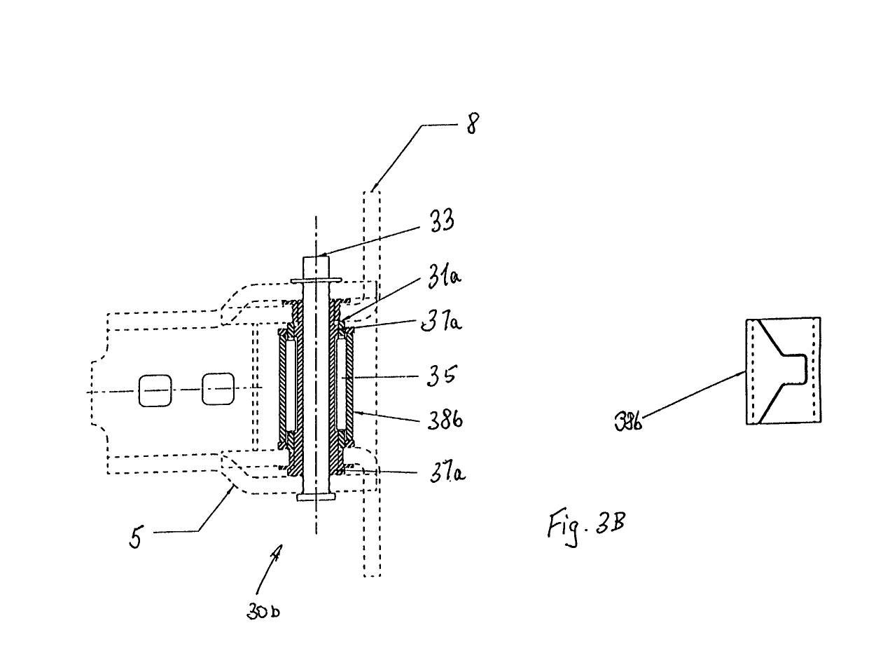

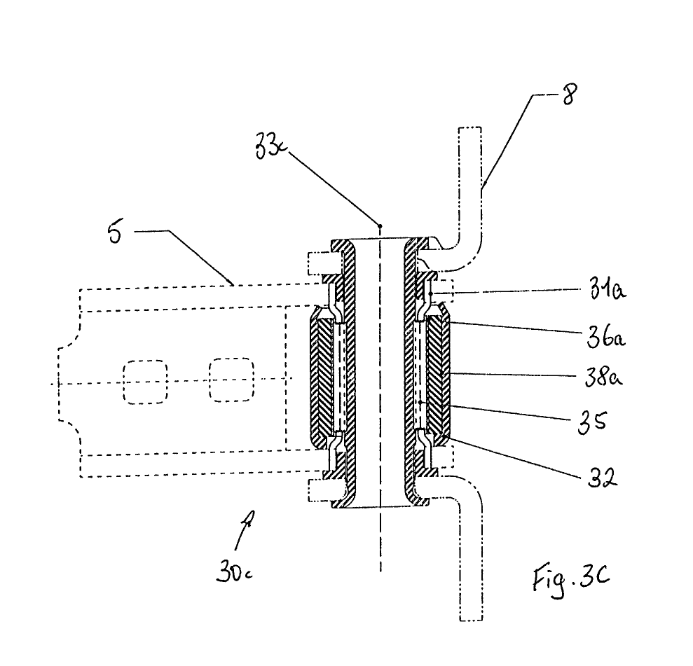

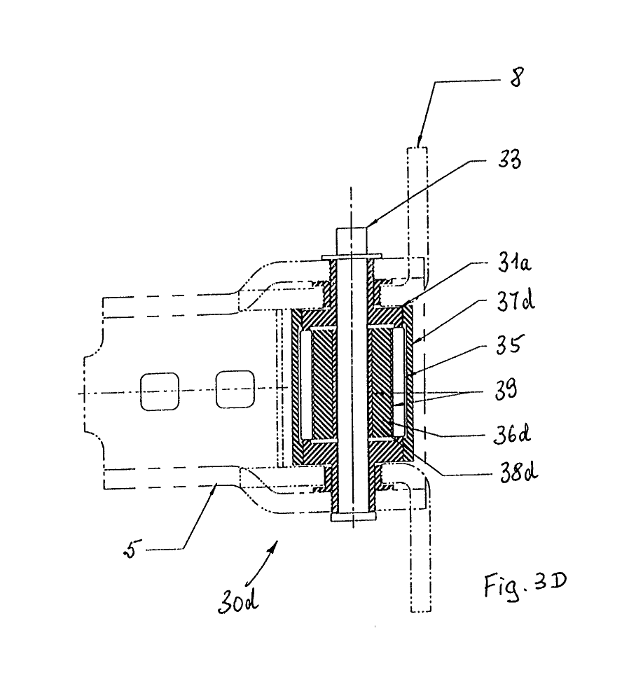

A third embodiment of the door check mechanism according to the invention is shown in FIGS. 3A-3D. Like the first embodiment, the door check mechanism includes a fixed member 5 which is attached to the vehicle frame (not shown) and a closure member 8 (door hinge) which is pivotally moveable in relation to the vehicle frame about a pivot pin or pivot axis. The door check device represented herein is axial in operation and shown in three modifications which differ primary in the spring type and the arrangement of the detents. The designs depicted in FIGS. 3A, 3C and 3D have an elastomer spring, whereas the design of FIG. 3B has a flat plate spring. The designs depicted in FIGS. 3A and 3B have internal detent sleeves, the design of FIG. 3C has an internal detent tube which obviates the need for a pivot pin, whereas the design of FIG. 3C has an external detent sleeve.

Referring now to FIG. 3A, the radial door check 30a operates by having a center hinge pin 33, with a detent sleeve 37a keyed to it. The hinge pin 33 extends through the vehicle half of the hinge to the door half of the hinge and is keyed to the door half of the hinge. A plurality of needle rollers 35, for example, four needle rollers, are preferably equally spaced around the detent sleeve 37a. Detents 39a in the detent sleeve 37a provide the stop positions for the door through engagement with the rollers 35 which are urged into the detents 39a by the inward biasing force generated by the elastomer spring 38a. The plurality of elongated needle rollers 35 is used to better distribute the contact forces on the detent sleeve 37a. The cage 31 a which holds the needle rollers 35 is locked to the vehicle hinge half of the hinge through the hinge pin 33. When the door is opened or closed, the cage 31a forces the rollers 35 around the detent sleeve 37a. The elastomer spring 38a has a split inner race 36a that provides a rolling surface for the needle rollers 35 and an outer spring support housing 32 that provides the reaction surface for the elastomer spring 38a. Alternatively, the hinge pin could also be locked to the vehicle half of the hinge and the cage be locked to the door half of the hinge.

In the modified radial door check 30b depicted in FIG. 3B, the spring force is provided by a flat plate spring 38b. The spring is preferably split to allow it to yield for providing the biasing force on the needle rollers 35. Replacing the elastomer spring with the flat plate spring 38b makes the design more compact and also eliminates the need for the split inner race 36a and the outer spring support housing 32.

In another modified radial door check 30c depicted in FIG. 3C, the hinge pin 33 of FIG. 3A can be replaced by a one-piece detent tube 33c that is connected directly to the door hinge, with the detents being arranged on the detent tube 33c. This arrangement reduces the parts count in the assembly and eliminates the lock feature between the hinge pin and the detent sleeve.

In yet another modified radial door check 30d depicted in FIG. 3D, the detent sleeve 37d is formed to coincide with the outermost section of the part, namely the housing 32. The cage 31a and needle roller 35 assembly are in this case be located inside of the detent sleeve 32. An inner spring support 39 supports the elastomer spring 38d with a split inner race 36d to produce the spring force that urges the needle rollers 35 against the detents disposed in the outer detent sleeve 37d. The mechanism 30d operates in the same as the mechanisms 30a-30c, except that the rollers 35 are biased in an outward direction instead of an inward direction. This allows the use of larger needle rollers 35 and provides a longer momentum arm from the center of rotation of the hinge, thus reducing the force on the rollers 35.

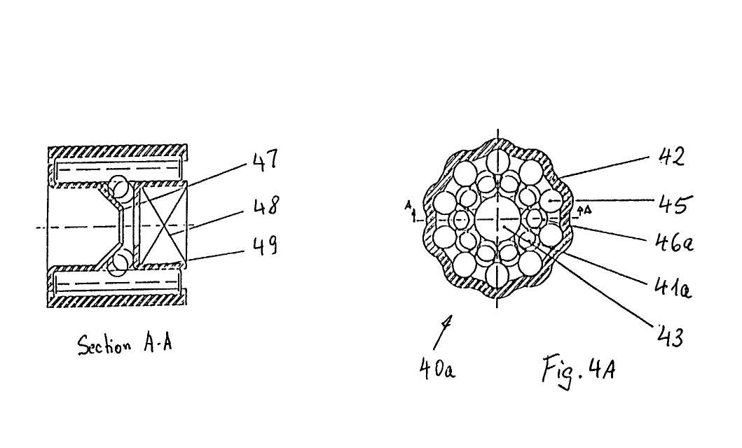

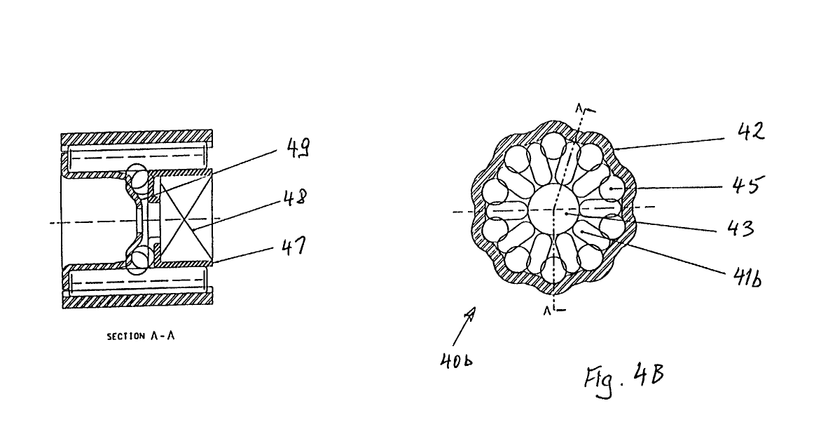

A fourth embodiment of the door check mechanism according to the invention is shown in the two designs depicted in FIGS. 4A and 4B. The following proposal of a checking mechanism for a vehicle door is presented in two optional constructions, integrated into the door hinge. The closure member (door) is moveable in relation to the vehicle frame.

The first door check design of the fourth embodiment (FIG. 4A) includes a cylindrical fluted outer housing 42, and a plurality of rollers 45 and balls 46a captured between the outer housing 42 and two inner cylindrical housings (47-upper inner housing; 49-lower inner housing). One inner housing 49 is biased by a spring 48 against the other inner housing 47, with both inner housings 47, 49 being supported by a hinge pin 43 affixed to the closure member (door; not shown).

A cage 41a is provided to maintain proper ball spacing. Both the upper and lower inner cylinders (47, 49) have features that trap the balls 46a and allow them to move both radially and axially, while the rollers 45 move radially in accordance with the flutes of the housing 42 which is affixed to the vehicle body (not shown).

The arresting force and angular position of the door check can be adjusted by changing the flute profile of the housing 42 as well as features of the inner cylinders and the pressure of the spring 48. The design is modular, and can be used for either right-hand or left-hand application and adapted to differing hinge designs.

The second design 40b depicted in FIG. 4B eliminates the balls 46a of the first design 40a, with the rollers 45b which are separated by rib guides 41b being urged directly against the flutes of the housing 42 by spring 48. In all other aspects, the design 40b operates in the same manner as the design 40a.

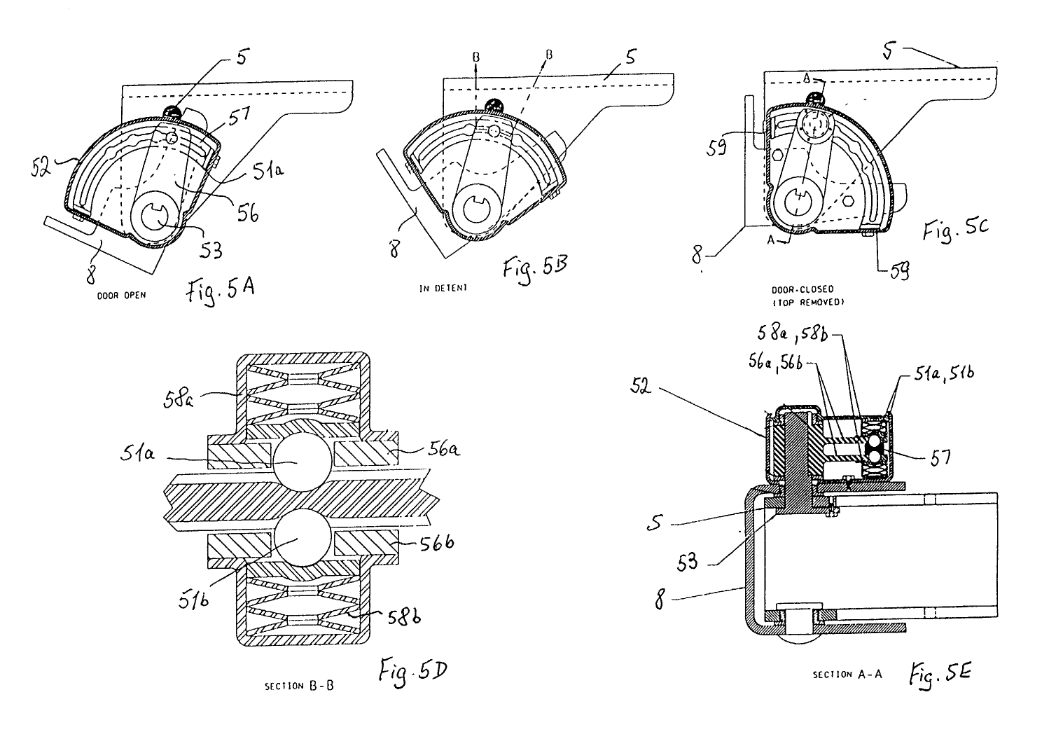

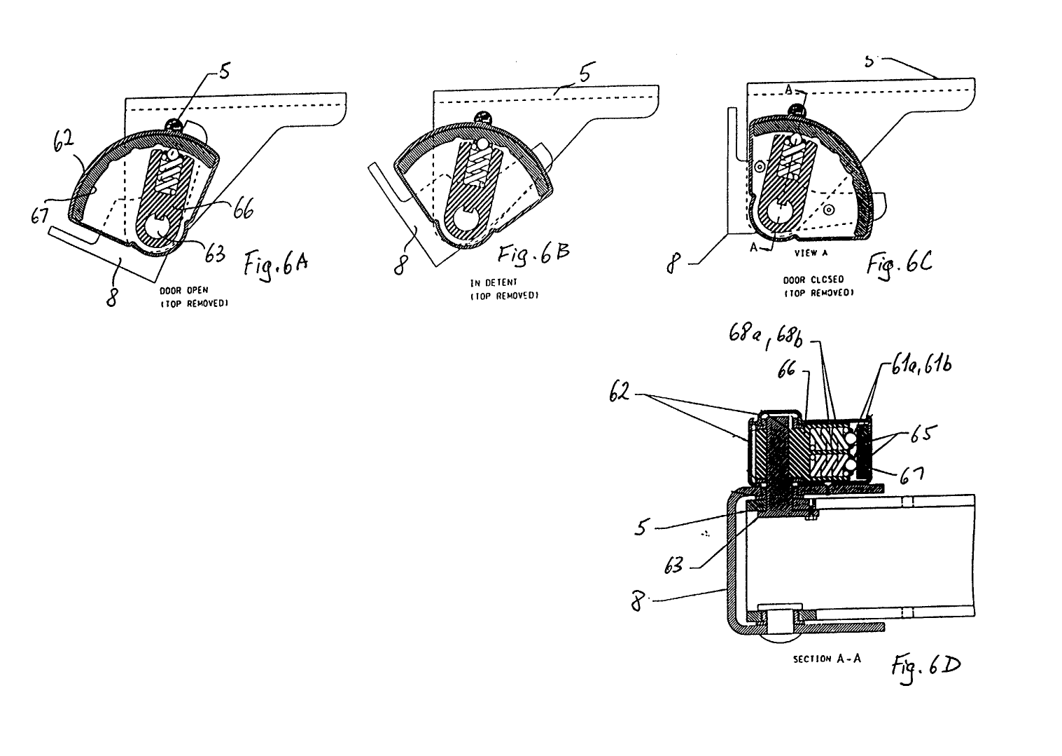

A fifth embodiment of the door check mechanism according to the invention is shown in FIGS. 5A-E and FIGS. 6A-D. Like the embodiment depicted in FIGS. 1A-E, the fixed member 5 is attached to the vehicle frame (not shown) and the closure member 8 (door hinge) is pivotally moveable in relation to the vehicle frame about a pivot pin 53. The checking mechanism has a housing 52 and detent plate 57 which is fixedly attached to the housing 52. The pivot pin 53 is secured to the frame and therefore stationary. The housing 52 with detent plate 57 are mounted rotatably to pin 53. Opposing arms 56a, 56b internal to the housing 52 extend radially outwardly from the pivot pin 53 and hold paired ball elements 51a, 51b on their free ends. Pin 53 is fixed to the vehicle body (not shown).

FIG. 5A shows the vehicle door in the open position, FIG. 5B in a detent position, and FIG. 5C in the closed position. FIG. 5C is a cross sectional view of FIG. 5B along the lines B-B. The detent plate 57 is captured between the paired balls 51a, 51b, which are pressed toward the detent plate 57 by springs 58a, 58b located behind each ball 51a, 51b opposite the detent plate 57. The door checks are defined by the retaining characteristics of the detent profile of the detent plate 57.

The arresting force of the door check which is integrated into the door hinge can be adjusted by changing the profile of the detent plate 57 and/or the pressure of the opposing springs 58a, 58b. The mechanism is modular and can be used with various hinge designs with either right-handed or left-handed doors. The housing 52 encloses the entire mechanism, hence excluding outside contaminants and retaining lubricant for the life of the product.

In a sixth embodiment of this invention depicted in FIGS. 6A-D, the detent plate 67 is affixed to the wall of the housing 62 which is affixed to the closure member. FIG. 6A shows the vehicle door in the open position, FIG. 6B in a detent position, and FIG. 6C in the closed position. FIG. 6D which is a cross sectional view of FIG. 6C taken along the line A-A of FIG. 6C shows an arm 66 internal to the housing 62 and keyed to the pivot pin 63 which is fixed to the vehicle body (not shown). The arm 66 extends radially outwardly from the pivot pin 63 and holds spring elements 61a, 61b with optional ball supports 65 that urge ball elements 61a, 61b against the detent plate 67. The door check is defined by the retaining characteristics of the profile on the face of the detent plate 67.

The arresting force and angular position of the door check which is integrated into the door hinge can be adjusted by changing the profile of the detent plate 67 and/or the pressure of the opposing springs 68a, 68b. The mechanism is modular and can be used with various hinge designs with either right-handed or left-handed doors. The housing 62 encloses the entire mechanism, hence excluding outside contaminants and retaining lubricant for the life of the product.

While the invention has been illustrated and described as embodied in a door hinge check for a vehicle door, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A door catch for a door hinge comprising
a housing affixed to a first half of the door hinge;
a shaft extending through the housing and connecting the other half of the door hinge to the first half to allow the first half to rotate about the shaft; and
a detent mechanism defining a plurality of detent positions of the door hinge,
wherein the detent mechanism is enclosed in the housing so as to be sealed against the environment.

2. The door catch of claim 1, wherein the detent mechanism includes a detent plate having detents and being secured to the housing, and an arm keyed to the shaft and supporting a roller, wherein the detent plate is biased against the roller and the shaft is non-rotatably secured to the other half of the door hinge.

3. The door catch of claim 2, wherein the detent plate is supported in the housing by a pivot pin.

4. The door catch of claim 2, wherein detent plate is biased against the roller by an elastomer spring.

5. The door catch of claim 1, wherein the detent mechanism includes a detent plate having detents and being affixed to the housing, and a support keyed to the shaft and supporting at least one ball or needle roller, wherein the at least one ball or needle roller is biased against the detent plate and the shaft is non-rotatably secured to the other half of the door hinge.

6. The door catch of claim 5, wherein the at least one ball or needle roller is biased against the detent plate in a direction perpendicular to a longitudinal direction of the shaft.

7. The door catch of claim 5, wherein two balls are arranged on opposing sides of the detent plate and biased against the detent plate in a direction parallel to a longitudinal direction of the shaft.

8. The door catch of claim 5, wherein the detent plate is a circular detent plate arranged on an end of the shaft which penetrates the center of the detent plate, and the support is in the form of a cage and thrust plate, wherein the thrust plate is biased against the detent plate in a direction parallel to a longitudinal direction of the shaft.

9. The door catch of claim 5, wherein the detent mechanism has two spaced-apart circular detent plates arranged on opposing ends of the shaft which penetrates the center of the detent plates, and the support is in the form of respective cages and thrust plates associated with each of the detent plates, wherein the thrust plates are biased in opposing directions against the respective detent plates.

10. The door catch of claim 8, wherein the thrust plate is biased by an elastomer spring.

11. The door catch of claim 8, wherein the thrust plate is biased by a compression spring.

12. The door catch of claim 8, wherein the thrust plate is biased by a belleville spring.

13. The door catch of claim 9, wherein the thrust plate is biased by an elastomer spring.

14. The door catch of claim 9, wherein the thrust plate is biased by a compression spring.

15. The door catch of claim 9, wherein the thrust plate is biased by a belleville spring.

16. The door catch of claim 1, wherein the detent mechanism includes a detent sleeve with detents operatively connected to the shaft, and a cage secured to the housing and supporting at least one roller, wherein the at least one roller is biased against the detent sleeve and the shaft is non-rotatably secured to the other half of the door hinge.

17. The door catch of claim 16, wherein the detent sleeve is formed integrally with the shaft.

18. The door catch of claim 17, wherein the shaft is a hollow tube.

19. The door catch of claim 1, wherein the detent mechanism wherein a plurality of detents being formed integrally with the housing, and a cage secured to the shaft and supporting at least one roller, wherein the at least one roller is biased against the housing in a direction perpendicular to a longitudinal direction of the shaft for engagement with the detents and the shaft is non-rotatably secured to the other half of the door hinge.
